(19) United States
(12) Patent Application Publication
(10) Pub. No.: US 2006/0171550 A1
(43) Pub. Date: Aug. 3, 2006

(54) BTE hearing aid component and hearing aid comprising same

(75) Inventors: Paul M. Bryant, Longwood, FL (US); Marc McLarnon, Longwood, FL (US)

Correspondence Address: Michael E. Sellers;Gable & Gotwals, 10th Floor, 100 W. 5th Street, Tulsa, OK, 74103, US

(73) Assignee: Audina Hearing Instruments, Inc.

(21) Appl. No.: 11/412,766

(22) Filed: Apr. 27, 2006

Related U.S. Application Data
(60) Provisional application No. 60/783,361, filed on Mar. 17, 2006.

(51) Int. Cl. H04R 25/00

(52) U.S. Cl. 381/330; 381/322

(57) ABSTRACT

A behind-the-ear hearing aid component employs a multi-functional module easily replaced to enhance repairability and time to market. The multi-functional module is removably secured to a case that carries a microphone, a programming system that receives and stores one or more hearing aid programs, an optional selector for selecting one of a plurality of hearing aid programs, a signal conditioning circuit for conditioning the microphone signal according to a hearing aid program to produce a conditioned microphone signal, and a battery for powering the hearing aid component. A receiver converts the conditioned microphone signal to conditioned sound that is output to an external sound conductor, such as an earhook or tube and tip, which conducts the conditioned sound to an ear of the user.

### REFERENCE TO PENDING APPLICATION

This application claims priority to provisional patent application No. 60/783,361 filed on Mar. 17, 2006.

### FIELD OF THE INVENTION

The present invention relates generally to hearing assistance devices and audio communication devices. More particularly, the present invention relates to an improved Behind-The-Ear (BTE) or Over-The-Ear (OTE) hearing aid device employing a modular component uniquely configured to enhance functionality, serviceability, maintainability, reliability, cost, and product time to market.

### BACKGROUND OF THE INVENTION

Behind-the-Ear (BTE) hearing aids are worn behind the ear and are typically connected to a plastic tube and then to a custom earmold or a standard tip that fits inside the outer ear. The components are housed in a case that sits behind or on top of the ear. A fitting tubing and a custom made earmold directs the sound to the ear canal. Sound is directed from the hearing aid, through the tubing, and through the earmold or tip to the eardrum. These hearing aids can be modified with connections to external sound sources such as auditory training equipment, inductive loop systems, telephones, mobile telephones, infrared listening systems, television or streaming audio.

BTE hearing aids can provide more amplification than smaller devices and in general offer more flexibility and functionality. They are available in the programmable, digital, and conventional circuit styles, and in several colors to suit personal preference, fashion and for hair and skin tone matching.

One drawback to small BTE hearing devices is that, because of their relatively compact size, configuration and complexity of the components, they are generally difficult to manufacture, repair and service. The complex components are critically placed into the case to accommodate the functional requirements, as well as to meet the acoustical challenges of packaging and final assembly. This requires a highly skilled technician to manufacture, repair or service the device.

What is needed, therefore, is a BTE hearing device that is easier to manufacture, by using a pre-assembled multi-functional modular device, which is pre-tested and contains multiple key components. This provides proven functionality, reliability and offers ease in maintainability. Employing the multi functional module design eliminates the necessity to develop, design and manufacture unique tooling for many key components that are typically required in traditional BTE product developments. The benefits are evident—reduced cost, ease of service and repair, and shorter product development cycles resulting in shorter lead times to market.

### BRIEF SUMMARY OF THE INVENTION

The present invention achieves its objectives by providing a behind-the-ear hearing aid component having a case for carrying a multi-functional module removably secured to the case. The multi-functional module includes a microphone for sensing sound and producing a microphone signal corresponding to the sensed sound, a programming system for receiving and storing one or more hearing aid programs, a signal conditioning circuit for receiving and conditioning the microphone signal according to a hearing aid program selected by the user to produce a conditioned microphone signal, and a battery for powering the hearing aid. A receiver (i.e., speaker) converts the conditioned microphone signal to conditioned sound that is output by a sound outlet of the receiver. The hearing aid component is configured for being removably secured to an external sound conductor (such as an earhook or tube and tip) that conducts conditioned sound from the sound outlet to an ear of a user.

In accordance with a further aspect of the invention, a plurality of user selectable hearing aid programs are received and stored by the programming system. To facilitate selection of one of the hearing programs, a selector (such as a push button switch) is provided.

If desired, a second microphone may be employed in the hearing aid component external to the multi-functional module.

In one embodiment of the invention, the sound outlet extends outwardly from the case and functions as a male connector that engages a corresponding female connector of the external sound conductor.

The present invention also contemplates a behind-the-ear hearing aid having a behind-the-ear component of the type described above. A sound conductor is removably secured to the behind-the-ear component to conduct conditioned sound output by the receiver to an ear of the user.

### BRIEF DESCRIPTION OF THE DRAWINGS

Preferred embodiments of the invention will now be described in further detail. Other features, aspects, and advantages of the present invention will become better understood with regard to the following detailed description and accompanying drawings (which are not to scale) where:

FIG. 1 is a side view of a BTE hearing aid component configured for attachment to an earhook or tube and tip configuration according to the invention;

FIG. 2 is a side view of the BTE hearing aid component of FIG. 1 with a portion of the case removed to show internal features;

FIG. 3 is a sequential side view of the BTE hearing aid component of FIG. 1 illustrating insertion of a multi-functional module;

FIG. 4 is the sequential side view of FIG. 4 with a portion of the case of the BTE hearing component removed to show internal features;

FIG. 5 is an exploded side view of the BTE hearing aid component of FIG. 1 showing installation of the multi-functional module with the aid of a mounting frame;

FIG. 6 is a three-dimensional view illustrating battery access features for the BTE hearing component of FIG. 1; and

FIG. 7 is a plan view of a flex circuit board for use in the BTE hearing aid component of FIG. 1.

### DETAILED DESCRIPTION OF THE PREFERRED EMBODIMENT(S)

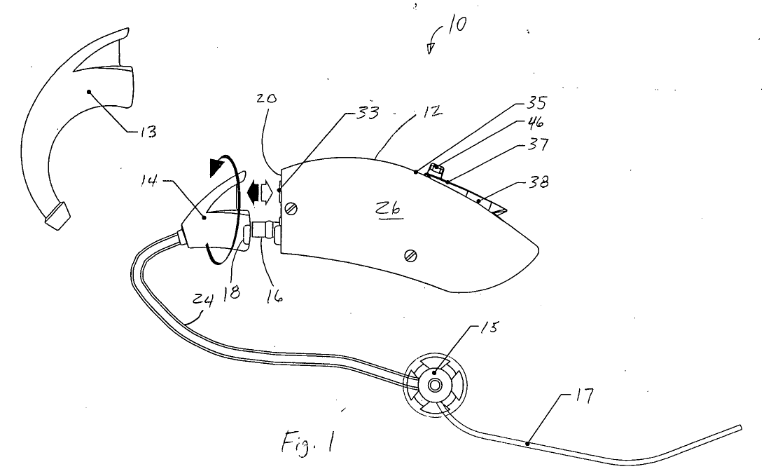

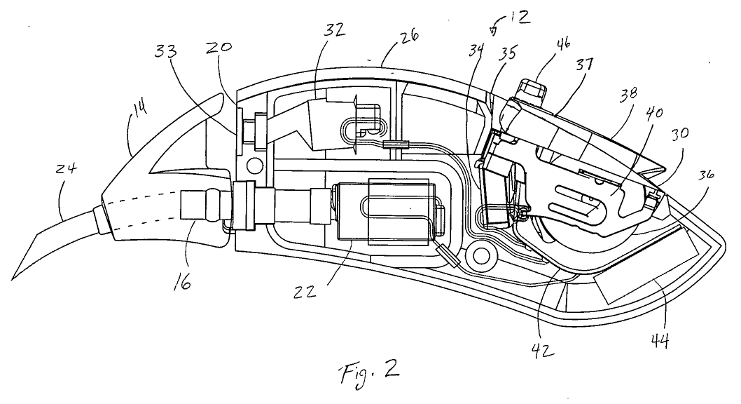

Turning now to the drawings wherein like reference characters indicate like or similar parts throughout, there is shown in FIGS. 1 and 2 an arrangement of a BTE hearing aid 10 incorporating a BTE hearing aid component 12 for being removably secured to a sound conductor such as an earhook 13 or, preferably, a tube and tip 14 according to the invention. A suitable tube and tip 14 is one available from GN RESOUND™ under its CLEAR TUBE SYSTEM™ brand name. As the name implies, tube and tip 14 includes a tube 24 that terminates at an optional ear bud or tip 15 through which sound output by component 12 is conducted to an ear of the user. A retention guard helps to hold the hearing aid 10 in place during use.

Component 12 includes a case 26 that houses one or more electronic and other functions, such as microphones, multiple microphones, programming access, battery door, battery contacts, memory button, volume control, telecoil, suspensions, wiring and associated hardware, of the hearing aid 10 and is removably secured to the tube and tip 14. In a preferred embodiment, a male coupler 16, which is connected to an internal output receiver or speaker 22 (FIG. 2) thru a tubing assembly at one end, extends beyond face 20 of component 12 at the other end. Coupler 16 functions as a male connecting part of component 12 and interfaces with female connecting part 18 of the tube and tip 14.

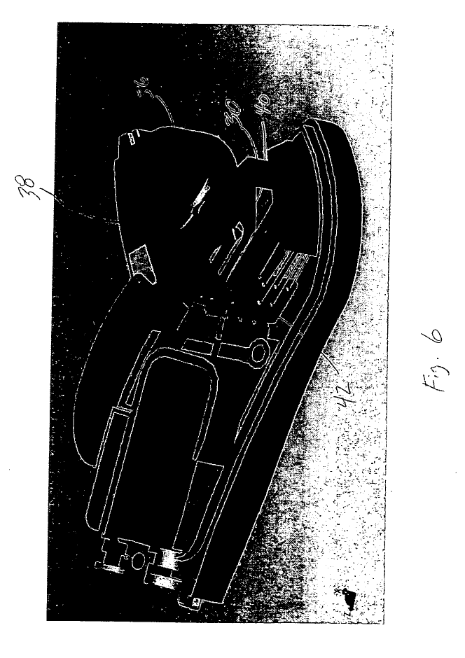

With continued reference to FIGS. 1 and 2, component 12 includes an outer case 26 that houses a multi-functional module 30, receiver 22, and an optional microphone 32 with a microphone inlet 33. A microphone opening 35 in case 26 facilitates conduction of sound to microphone 34. Functions/components provided by a removably-secured, multi-functional module 30 may include any combination of: a microphone 34, programming system accessible by way of a programming interface 37 (such as a receptacle for receiving a programming cable or flex strip or an IR port for receiving wireless programming signals), battery 36, battery door 38 or other access, battery contacts 40, and a flex circuit board 42 or other electrical interface attached directly or indirectly by wires to a signal conditioning circuit 44 that receives and conditions (including amplification and/or filtering) the output from microphone 34 according to one or more hearing aid programs received from an external device (either during manufacturing or afterward) and stored in memory. In one embodiment, a single hearing aid program is stored in component 12. In an alternate embodiment, a plurality of user selectable hearing air programs is stored in component 12. If desired, additional microphones and receivers may be electrically connected to the flex circuit board 42 or other electrical interface of the multi-functional module 30 directly or indirectly by wires. If multiple hearing aid programs are to be stored in component 12, the multi-functional module 30 will preferably also include a push button switch 46 or other type of selector for selecting between the multiple hearing aid programs stored in memory in signal conditioning circuit 44. In a preferred embodiment, module 30 is a CU 10™ multi-functional module provided by SONION™. Multi-functional module 30 can be removably secured to the specially designed BTE case 26 directly or by the use of a mounting frame 27 (FIG. 5) incorporating mating features to secure the multi-functional module 30 to the outer case. Use of multi-functional module 30 in a BTE hearing aid 10 provides significant advantages over currently existing BTE hearing aids, including increased reliability, simplified manufacturing assembly processes, reduced manufacturing and development costs, improved service and maintenance, decreased product development cycle times and shortened product introduction times to market.

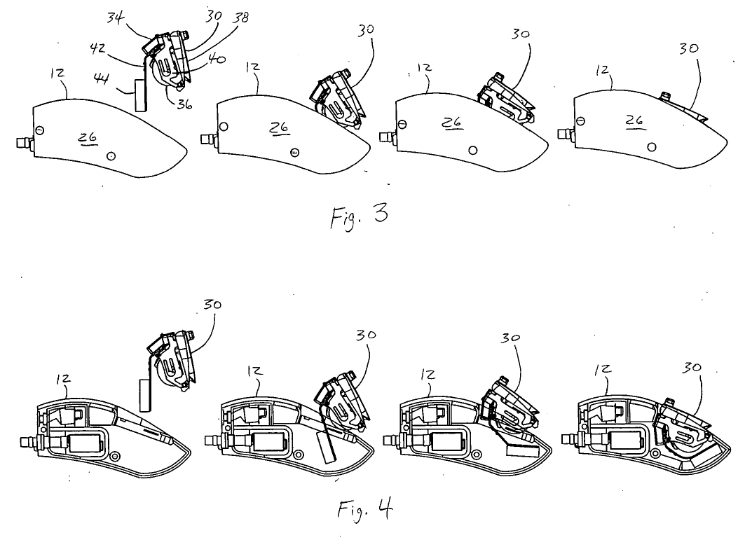

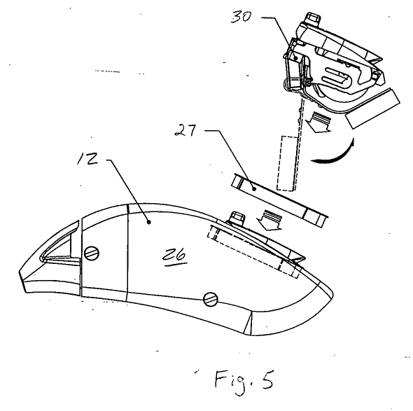

Repairing and servicing BTE hearing aids can be a difficult, costly and time-consuming activity even for highly skilled technicians. Patients often must wait days as their hearing aids are serviced and/or repaired. The BTE hearing aid 10 described herein is specially designed to improve or eliminate these difficulties by enabling component 12 to be quickly and easily serviced or repaired, as can be seen in the sequential illustrations of FIGS. 3 and 4.

Each of FIGS. 3 and 4 shows a preferred installation of multi-functional module 30 (going from left to right) and removal of multi-functional module 30 (going from right to left). As can be seen, the entire multi-functional module 30, including flex circuit board 42 and signal conditioning circuit 44, can be installed and removed as a single unit. To install the pre-programmed module 30, signal conditioning circuit 44 is first inserted through an opening formed in the outer case 26. Signal conditioning circuit 44 is followed into the case 26 by flex circuit board 42, microphone 34, battery 36, and battery terminals 40. The case opening through which module 30 is installed is closed by battery door 38. During installation, receiver 22 and microphone 32 are electrically connected to module 30, preferably by direct attachment of lead wires to flex circuit board 42. This process is reversed for removal of module 30 from the case 26. Alternatively, module 30 may be installed and removed through an access panel(s) forming a portion of case 26. For example, in one embodiment the case 26 is fabricated from two halves that are connected to form the case 26. In such an embodiment, the two halves of the case 26 may be separated to install or remove module 30, either with or without other elements of component 12 attached.

As described above, module 30 may be removably secured to a mounting frame 27 that is attached to or integral with the outer case 26. Alternatively, module 30 may be removably secured directly to the case 26 without the use of a mounting frame. In either embodiment, one or more fasteners (such as screws, clamps, snaps, adhesives, etc.) are employed to removably secure module 30 to the case 26.

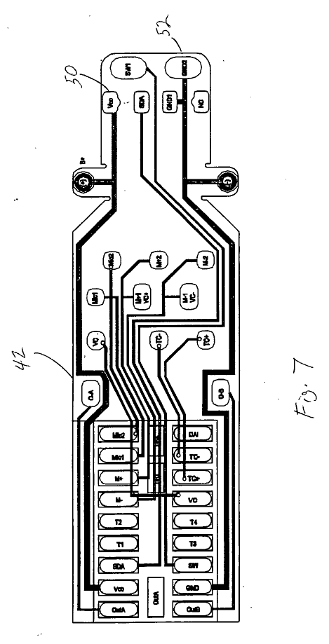

FIG. 6 provides a view of multi-functional module 30 with battery access door 38 in the open position. To access the battery 36, battery door 38 is opened as shown. With door 38 open, a new battery can be quickly and easily installed. Moving door 38 to its closed position (as shown in FIG. 3) places the battery 36 in electrical contact with contacts 40.

A preferred embodiment of an electrical interface in the form of a flex circuit board 42 will now be described with reference to FIG. 7. Electrical power is supplied to board 42 at pad 50 and returned or grounded at pad 52. Microphone 32 and receiver 22 are attached at appropriate pads of board 42, depending on the particular layout and configuration of board 42.

It will be understood that, in lieu of a flex circuit board 42, other forms of electrical interface may be employed instead. For example, in one embodiment the components of hearing aid 10 are simply hard wired to multi-functional module 30 without the use of a flex circuit board 42. In another embodiment, the electrical interface is wireless.

The foregoing description details certain preferred embodiments of the present invention and describes the best mode contemplated. It will be appreciated, however, that changes may be made in the details of construction and the configuration of components without departing from the spirit and scope of the disclosure. For example, although the invention has been described herein as preferably employed in a BTE hearing aid, it will be understood that the invention may be employed in other communication devices as well, such as MP3 players, telephones, and others. Therefore, the description provided herein is to be considered exemplary, rather than limiting, and the true scope of the invention is that defined by the following claims and the full range of equivalency to which each element thereof is entitled.

What is claimed is:

1. A behind-the-ear hearing aid component for producing and outputting conditioned sound to a sound conductor that conducts the conditioned sound to an ear of a user, said hearing aid component comprising:
a case for carrying:
a multi-functional module removably secured to the case, said multi-functional module including:
a microphone for sensing sound and producing a microphone signal corresponding to the sensed sound;
a programming system for receiving and storing one or more hearing aid programs;
a signal conditioning circuit for receiving and conditioning the microphone signal according to a hearing aid program, producing a conditioned microphone signal; and
a battery for powering the hearing aid component; and
a receiver for converting the conditioned microphone signal to conditioned sound, said receiver including a sound outlet;
wherein said hearing aid component is configured for being removably secured to an external sound conductor for conducting conditioned sound from the sound outlet to an ear of the user.

2. The hearing aid component of claim 1, further comprising a second microphone carried by said case external to said multi-functional module.

3. The hearing aid component of claim 1, wherein said programming system includes a programming interface for receiving one or more hearing aid programs from an external device.

4. The hearing aid component of claim 1, wherein said one or more hearing aid programs includes a plurality of user selectable hearing aid programs, said hearing air component further comprising a selector for selecting one of said plurality of user selectable hearing aid programs for conditioning the microphone signal.

5. The hearing aid component of claim 4, wherein said selector is a push button.

6. The hearing aid component of claim 1, wherein said sound conductor includes a tube and tip.

7. The hearing aid component of claim 1, wherein said sound conductor includes an earhook.

8. The hearing aid component of claim 1, wherein said multi-functional module is a CU 10™ multi-functional module provided by SONION™.

9. A behind-the-ear hearing aid component for producing and outputting conditioned sound to a sound conductor that conducts the conditioned sound to an ear of a user, said hearing aid component comprising:
a case for carrying:
a multi-functional module removably secured to the case, said multi-functional module including:
a microphone for sensing sound and producing a microphone signal corresponding to the sensed sound;
a programming system for receiving and storing one or more hearing aid programs;
a signal conditioning circuit for receiving and conditioning the microphone signal according to a hearing aid program, producing a conditioned microphone signal; and
a battery for powering the hearing aid component; and
a receiver for converting the conditioned microphone signal to conditioned sound, said receiver including a sound outlet extending outwardly from said case and configured for being removably secured to an external sound conductor for conducting sound from the sound outlet to an ear of the user.

10. A behind-the-ear hearing aid comprising:
a behind-the-ear component having:
a case for carrying:
a multi-functional module removably secured to the case, said multi-functional module including:
a microphone for sensing sound and producing a microphone signal corresponding to the sensed sound;
a programming system for receiving and storing one or more hearing aid programs;
a signal conditioning circuit for receiving and conditioning the microphone signal according to a hearing aid program, producing a conditioned microphone signal; and
a battery for powering the hearing aid; and
a receiver for converting the conditioned microphone signal to conditioned sound; and
a sound conductor removably secured to said behind-the-ear component for conducting conditioned sound from the receiver to the ear of a user.

11. The hearing aid of claim 10, wherein said behind-the-ear component is configured for being removably secured to an external sound conduit for conducting conditioned sound from the sound outlet to an ear of the user.

12. The hearing aid of claim 10, further comprising a second microphone carried by said case external to said multi-functional module.

13. The hearing aid of claim 10, wherein said programming system includes a programming interface for receiving said one or more hearing aid programs from an external device.

14. The hearing aid component of claim 10, wherein said one or more hearing aid programs includes a plurality of user selectable hearing aid programs, said hearing air component further comprising a selector for selecting one of said plurality of user selectable hearing aid programs for conditioning the microphone signal.

15. The hearing aid of claim 10, wherein said selector is a push button.

16. The hearing aid of claim 10, wherein said sound conductor includes a tube and tip.

17. The hearing aid of claim 10, wherein said sound conductor includes an earhook.

18. The hearing aid of claim 10, wherein said multi-functional module is a CU 10™ multi-functional module provided by SONION™.
